(19) United States
(12) Patent Application Publication
(10) Pub. No.: US 2005/0018452 A1
(43) Pub. Date: Jan. 27, 2005

(54) Contactless power supply

(75) Inventor: Wan Seok Seo, Cheonan-city (KR)

Correspondence Address: FITZPATRICK CELLA HARPER & SCINTO, 30 ROCKEFELLER PLAZA, NEW YORK, NY, 10112, US

(73) Assignee: Winia Mando Inc., Asan-city (KR)

(21) Appl. No.: 10/864,355

(22) Filed: Jun. 10, 2004

(30) Foreign Application Priority Data
Jun. 11, 2003 (KR) 2003-37600

(51) Int. Cl. H02M 3/335

(52) U.S. Cl. 363/16

(57) ABSTRACT

A contactless power supply is provided, which includes a main body; a primary circuit having a power input portion receiving main power, a switching circuit having a plurality of direct-current (DC) converter, and a primary transformer, which is disposed in one-side of the main body; and a secondary circuit having a secondary transformer which is disposed at a predetermined distance from the primary circuit and receiving power from the primary transformer contactlessly, a peripheral circuit which filters and rectifies the power, and a power supply unit supplying the rectified power to a control system. As described above, the contactless power supply has a long life span of use and a characteristic of non-occurrence of mis-operations as well as an efficient power transfer function even at the state of a low coupling coefficient and a large leakage inductance, due to a contactless power transfer, in which a load-side power supply control system is designed in various schemes so as to be adapted in various ways.

### BACKGROUND OF THE INVENTION

1. Field of the Invention

The present invention relates to a contactless power supply, and more particularly, to a contactless power supply having a long life span of use and a characteristic of non-occurrence of mis-operations as well as an efficient power transfer function even at the state of a low coupling coefficient and a large leakage inductance, due to a contactless power transfer, in which a load-side power supply control system is designed in various schemes so as to be adapted in various ways.

2. Description of the Related Art

Most of conventional motors, brake systems, or battery charging systems employ a contact power supply having a conventional contact circuit.

The contact power supply has comparatively simple and inexpensive merits but a limited life span. Also, since the contact power supply has a demerit that all circuits should be designed again when a control environment is varied, its use has been gradually reduced.

Further, as semiconductor technologies are being remarkably developed nowadays, a contactless power supply having a non-contact circuit is employed for an automatic sequence control.

However, in the case of the above-described contactless power supply, an operating program is not set up until it is connected to a machine on a job-site to then confirm which operation is performed. Accordingly, the number of times of modifying the program on the job-site becomes frequent. According to a trend of a large number of kinds of products and a small quantity of products and development of a production technology, the production system should have been frequently modified. As a result, a wiring connection should be altered or the entire system should be re-structured.

Thus, the applicant has developed a contactless power supply, for example, in order to supply stable power in which a motor rotator provided in a motor rectifies power stably.

The above-described contactless power supply cannot only be used for a motor but also has a long life span of use and a characteristic of non-occurrence of mis-operations, in which a load-side power supply control system is designed in various schemes so as to be adapted in various ways.

### SUMMARY OF THE INVENTION

To solve the above problems, it is an object of the present invention to provide a contactless power supply having a long life span of use and a characteristic of non-occurrence of mis-operations as well as an efficient power transfer function even at the state of a low coupling coefficient and a large leakage inductance, due to a contactless power transfer, in which a load-side power supply control system is designed in various schemes so as to be adapted in various ways.

To accomplish the above object of the present invention, there is provided a contactless power supply comprising: a main body; a primary circuit having a power input portion receiving main power, a switching circuit having a plurality of direct-current (DC) converter, and a primary transformer, which is disposed in one-side of the main body; and a secondary circuit having a secondary transformer which is disposed at a predetermined distance from the primary circuit and receiving power from the primary transformer contactlessly, a peripheral circuit which filters and rectifies the power, and a power supply unit supplying the rectified power to a control system.

Here, the primary and secondary transformers are made of a UU-shaped core, respectively.

A bobbin is mounted in both columns or the center of the UU-shaped core, respectively. Coils are wound in parallel connection with respect to each bobbin.

A core cross-sectional area of the secondary transformer is same as or larger than that of the primary transformer, between the cores of the primary and secondary transformers which oppose each other.

### BRIEF DESCRIPTION OF THE DRAWINGS

The above and other objects and advantages of the present invention will become more apparent by describing the preferred embodiments thereof in detail with reference to the accompanying drawings in which:

FIGS. 1A and 1B are a front view and a rear view of a contactless power supply according to the present invention, respectively;

FIG. 2 is a schematic circuitry diagram of the contactless power supply according to the present invention;

FIGS. 3A and 3B show examples that coils are wound around cores of primary and secondary transformers, according to each embodiment of the present invention; and

FIG. 4 shows a shape of a magnetic flux in which cross-sectional areas of cores of the primary and secondary transformers, according to each embodiment of the present invention.

### DETAILED DESCRIPTION OF THE INVENTION

Preferred embodiments of the present invention will be described with reference to the accompanying drawings. Hereinbelow, the same reference numerals are assigned with respect to the same components in each embodiment.

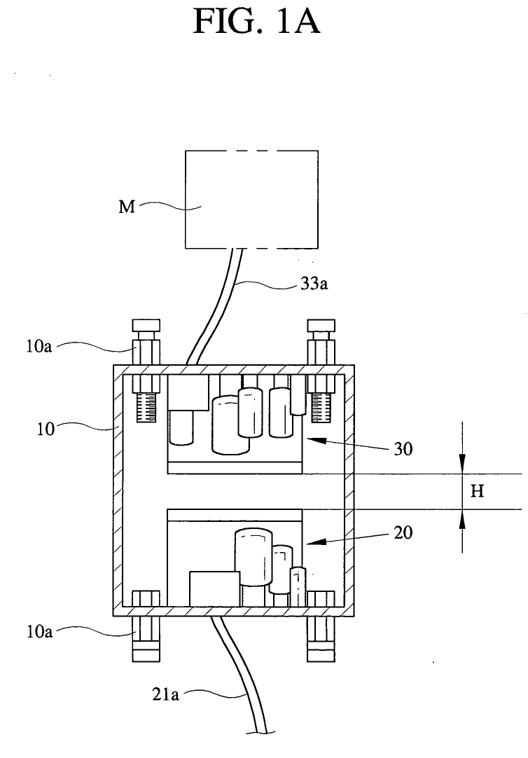

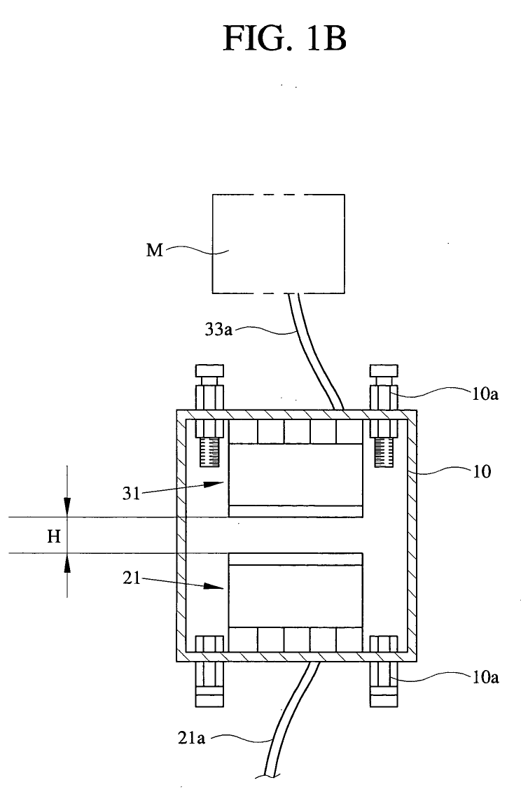

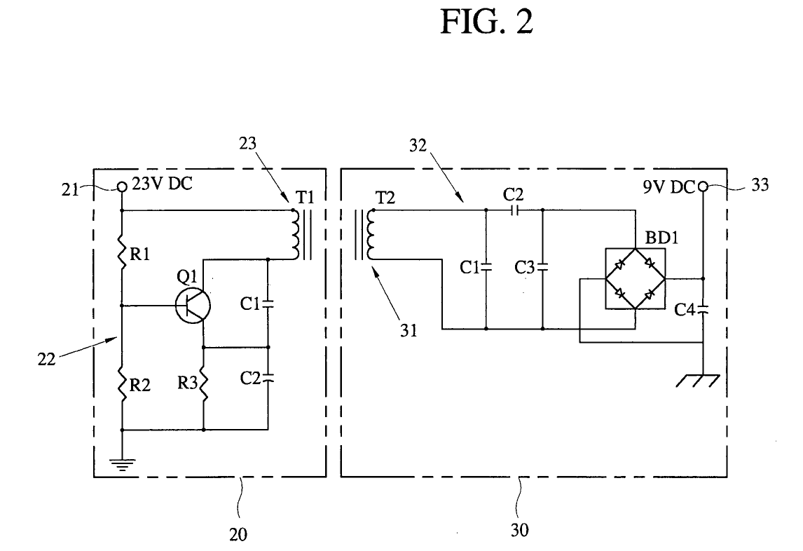

FIGS. 1A and 1B are a front view and a rear view of a contactless power supply according to the present invention, respectively. FIG. 2 is a schematic circuitry diagram of the contactless power supply according to the present invention.

As shown in FIGS. 1A to 2, the contactless power supply according to the present invention has a long life span of use and a characteristic of non-occurrence of mis-operations. Here, when a load-side power supply control system is designed in various schemes, the contactless power supply can be adapted in various ways.

As an example, referring to FIGS. 1A and 1B, the contactless power supply according to the present invention applies power to a rotating unit (not shown) of a motor (M), in order to make the motor (M) operate. The contactless power supply uses a magnetic induction phenomenon, in which a primary circuit 20 and a secondary circuit 30 are designed to have a separation or gap (H) mutually spatially. In operational principle, current flows in secondary coil 55 of the secondary circuit 30 by a magnetic field generated in the case that current flows in the primary coil 45 of the primary circuit 20, which is same as that of a general transformer. However, since the primary circuit 20 and the secondary circuit 30 are spatially separated from each other with the gap (H), the contactless power supply has a merit of supplying power efficiently at the state of a low coupling coefficient and a large leakage inductance.

The contactless power supply largely includes a main body 10, a primary circuit 20 and a secondary circuit 30. In the outside of the main body 10 are provided a plurality of coupling members 10a for coupling the main body 10 with a single system in the case that the contactless power supply according to the present invention is mounted in the single system.

As shown in FIG. 2, the primary circuit 20 includes a power input portion 21 receiving main power, a switching circuit 22 having a plurality of direct-current (DC) converters, and a primary transformer 23.

For example, main power of DC 23V is applied to the power input portion 21. Thus, a separate power input cable 21a is connected to the power input portion 21.

The switching circuit 22 is made of a single circuit including the power input portion 21 and the primary transformer 23. Here, a transistor Q1, resistors R1, R2, and R3, and capacitors C1 and C2 are provided in the switching circuit 22.

The secondary circuit 30 is disposed at a predetermined distance (H) from the primary circuit 20 in the main body 10. The secondary circuit 30 includes a secondary transformer 31 which receives power from the primary transformer 23 contactlessly, a peripheral circuit 32 which filters and rectifies the power, and a power supply unit 33 supplying the rectified power to a control system.

The peripheral circuit 32 include a filter, a rectifier and a smoother, in which capacitors C1, C2, C3 and C4 and a bridge BD1 are provided. Thus, power transferred from the primary circuit 20 on a non-contact basis is rectified in the secondary circuit 30, and then the rectified power is supplied to a motor rotating unit to make the motor (M) operate. Here, power supplied to the motor (M) via the power supply unit 33 become a voltage of DC 3V, which is supplied to the motor (M) via a separate power supply cable 33a.

Meanwhile, the primary and secondary transformers 23 and 31 are made of cores 40 and 50, respectively. Primary and secondary coils 45 and 55 are wound around primary and secondary cores 40 and 50, respectively. When the primary and secondary coils 45 and 55 are designed, proper cores are selected in order to heighten a coupling coefficient thereof.

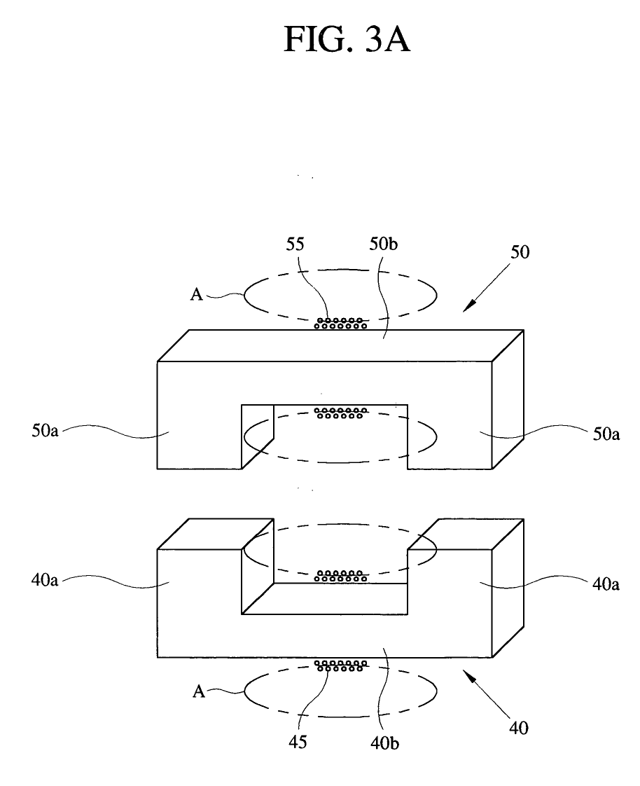

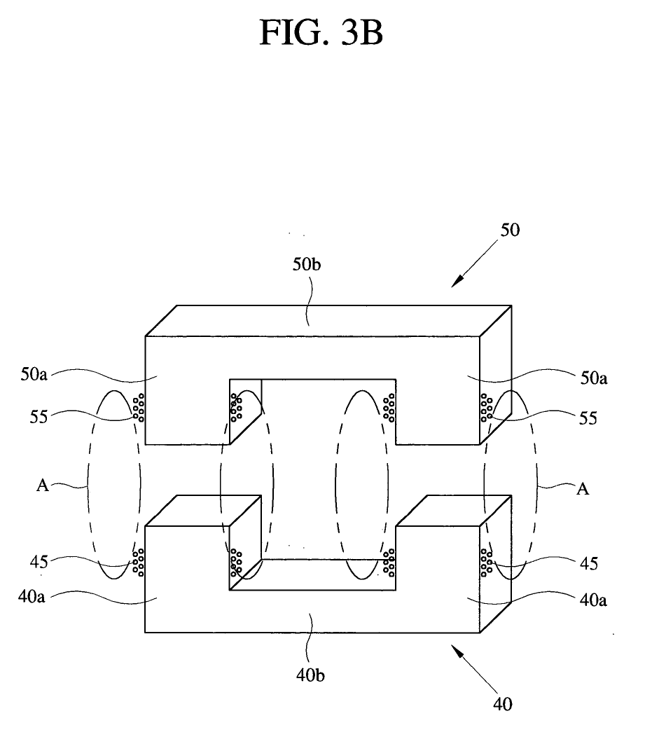

Of course, as cross-sections of the primary and secondary cores 40 and 50 opposing each other become larger, the coupling coefficient becomes larger. However, the primary and secondary cores 40 and 50 are spatially limited, and thus the cross-sectional areas thereof cannot be increased unlimitedly. Among various kinds of RM, EE, POT, Toroidal, and UU-shaped cores according to types of the product, the larger permeability core it is, the stronger magnetic flux intensity (A) it is. Considering this point, the contactless power supply according to the present invention employs UU-shaped cores 40 and 50 having a UU-shaped cross-section as shown in FIGS. 3A and 3B. The UU-shaped cores 40 and 50 have a merit of reducing a leakage of a magnetic flux (A) in comparison with that of a different shaped core in structure.

As described above, when the primary and secondary transformers 23 and 31 are designed using the UU-shaped cores 40 and 50, respectively, a leakage of the magnetic flux (A) can be reduced.

However, the coupling coefficient of the magnetic fluxes is varied by positions and methods of winding the primary and secondary coils 45 and 55 respectively wound around the primary and secondary cores 40 and 50.

For example, a larger coupling coefficient can be obtained when primary and secondary coils 45 and 55 are wound around both columns 40a and 50a of primary and secondary cores 40 and 50 as shown in FIG. 3B, than that obtained when the primary and secondary coils 45 and 55 are wound around the central portions 40b and 50b of the primary and secondary cores 40 and 50 as shown in FIG. 3A and the primary and secondary coils 45 and 55 are wound around one of the columns 40a and 50a of the primary and secondary cores 40 and 50 which is not shown.

Here, according to the employed winding method, bobbins (not shown) are mounted in both columns 40a and 50a of the primary and secondary cores 40 and 50, and then primary and secondary coils 45 and 55 are wound thereof in mutually parallel connection.

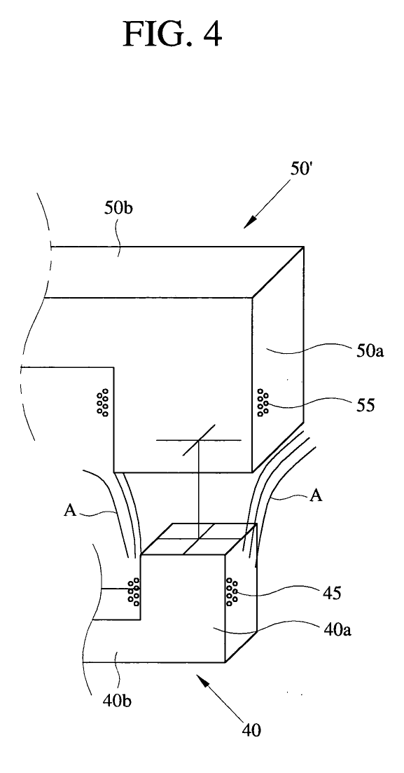

In other to efficiently cross-coupling a magnetic flux (A) generated from the primary circuit 20 with the other magnetic flux, a cross-sectional area of the secondary core 50′ should be designed a little larger than that of the primary core 40 as shown in FIG. 4. The reason resides in the fact that a leakage flux (A) is reduced as the cross-sectional area of the secondary core 50′ opposing the primary core 40 becomes larger than that of the primary core 40, to accordingly heighten a coupling coefficient. Thus, when main power of DC 23V is applied to the power input portion 21 in the primary circuit 20, the applied main power is rectified in the switching circuit 22. Then, the rectified power is transferred to the secondary transformer 31 of the secondary circuit 30 via the primary circuit 23.

Of course, since the primary and secondary circuits 20 ad 30 are separated from each other by a mutual gap (H), power is transferred between the primary and secondary circuits 20 ad 30 on a non-contact basis. That is, when power is supplied to the primary coil 45 of the primary core 40 forming the primary transformer 23, current flows in the secondary coil 55 of the secondary core 50 due to a magnetic flux generated by the power supplied. As described above, when current flows in the secondary coil 55, the current is filtered and rectified via the peripheral circuit 32 to then be supplied to the power supply unit 33.

Also, when power of the rectified DC 9V is applied to the power supply unit 33, the power is supplied for a motor rotating portion (not shown) via the power supply cable 33a, to thus make a motor (M) operate.

As described above, the present invention provides a contactless power supply having a long life span of use and a characteristic of non-occurrence of mis-operations, due to a contactless power transfer, in which a load-side power supply control system is designed in various schemes so as to be adapted in various ways.

The present invention has been described with respect to embodiments of driving a motor (M) with a contactless power supply, but is not limited thereto. That is, the present invention can be applied to various types of control systems such as a brake system for an electric motor or a battery charging system in addition to a motor (M).

As described above, a contactless power supply according to the present invention provides a number of effects of providing a long life span of use and a characteristic of non-occurrence of mis-operations as well as an efficient power transfer function even at the state of a low coupling coefficient and a large leakage inductance, due to a contactless power transfer, in which a load-side power supply control system is designed in various schemes so as to be adapted in various ways.

1. A contactless power supply comprising:
a main body;
a primary circuit having a power input portion receiving main power, a switching circuit having a plurality of direct-current (DC) converter, and a primary transformer, which is disposed in one-side of the main body; and
a secondary circuit having a secondary transformer which is disposed at a predetermined distance from the primary circuit and receiving power from the primary transformer contactlessly, a peripheral circuit which filters and rectifies the power, and a power supply unit supplying the rectified power to a control system.

2. The contactless power supply of claim 1, wherein the primary and secondary transformers are made of a UU-shaped core, respectively.

3. The contactless power supply of claim 2, wherein a bobbin is mounted in both columns or the center of the UU-shaped core, respectively, and coils are wound in parallel connection with respect to each bobbin.

4. The contactless power supply of claim 3, wherein a core cross-sectional area of the secondary transformer is same as or larger than that of the primary transformer, between the cores of the primary and secondary transformers which oppose each other.
